(19) United States
(12) Patent Application Publication
(10) Pub. No.: US 2026/0168306 A1
(43) Pub. Date: Jun. 18, 2026

(54) VEHICLE DOOR SUPPORT DEVICE

(71) Applicant: U-Shin Ltd., Nagano (JP)

(72) Inventors: Mikio YAMAGATA, Hiroshima (JP); Toshiyuki YAHARI, Hiroshima (JP)

(21) Appl. No.: 19/413,089

(22) Filed: Dec. 9, 2025

(30) Foreign Application Priority Data
Dec. 18, 2024 (JP) 2024-221660

(51) Int. Cl. E05F 15/622

(52) U.S. Cl. CPC E05F 15/622; E05Y 2201/21; E05Y 2201/474; E05Y 2900/546

(57) ABSTRACT

The door support device includes an active type first support member and a passive type second support member. The first coil spring of the first support member and the second coil spring of the second support member are configured such that the spring load difference at the fully closed position is smaller than the spring load difference at the fully opened position, and the second spring load is larger than the first spring load at the fully opened position.

### CROSS REFERENCE TO RELATED APPLICATION

This application claims benefit of priority to Japanese Patent Application 2024-221660, filed on Dec. 18, 2024, the entire content of which is incorporated herein by reference.

### BACKGROUND ART

### Technical Field

The present invention relates to a vehicle door support device.

### Related Art

JP 7252058 B2 discloses a vehicle door support device that supports a door with respect to a vehicle body. The door support device includes an active type support member attached to one side in the width direction and a passive type support member attached to the other side in the width direction. Each support member includes a fixed housing, a movable housing, a coil spring that advances the movable housing from the fixed housing, a spindle attached to the fixed housing, and a spindle nut attached to the movable housing.

The active type support member includes a motor that rotationally drives the spindle, and the movable housing actively moves forward and backward with respect to the fixed housing. The passive type support member does not include a motor, and the movable housing passively moves forward and backward with respect to the fixed housing. The passive type support member includes a brake that applies rotational resistance to the spindle instead of the motor.

### SUMMARY

If there is a difference between the axial load of the active type support member and the axial load of the passive type support member, a load acts on the door due to the axial load difference, which may affect the stable operation of the door. In the door support device, there is room for improvement in equalization between the axial load of the active type support member and the axial load of the passive type support member.

An object of the present invention is to equalize an axial load of an active type support member and an axial load of a passive type support member.

An aspect of the present invention provides a vehicle door support device including: a first support member and a second support member that support a door with respect to a vehicle body, in which each of the first support member and the second support member includes: a tubular fixed housing having a first end portion connected to one of the vehicle body and the door and a second end portion opposite to the first end portion; a tubular movable housing that has a third end portion connected to the other of the vehicle body and the door, is accommodated in the fixed housing from the second end portion on a side opposite to the third end portion, and is movable in an axial direction with respect to the fixed housing; a spindle rotatably supported within the fixed housing; a spindle nut screwed to the spindle and coupled to the movable housing; and a coil spring that biases the movable housing in a direction in which the movable housing advances from the fixed housing, the first support member is an active type support member including a motor that drives the spindle of the first support member, and the second support member is a passive type support member that follows an operation of the door, and when the coil spring of the first support member is a first coil spring, a component of a first axial load acting on the first support member from the first coil spring is a first spring load, the coil spring of the second support member is a second coil spring, a component of a second axial load acting on the second support member from the second coil spring is a second spring load, and a difference between the first spring load and the second spring load at the same door position is a spring load difference, the first coil spring and the second coil spring are configured such that the spring load difference when the door position is in the fully closed position is smaller than the spring load difference when the door position is in the fully opened position, and the second spring load is larger than the first spring load when the door position is the fully opened position.

In the above configuration, when the door is held at the fully closed position, the motor is stopped. The first axial load of the first support device (active type support device) is equivalent to the first spring load, and the second axial load of the second support device (passive type support device) is equivalent to the second spring load. When the door is at the fully closed position, the spring load difference is relatively small. Therefore, when the door is held at the fully closed position, the difference between the first axial load and the second axial load decreases, and the load acting on the door due to the axial load difference is reduced. Note that the door is held at the fully closed position for most of the period of practical use of the vehicle and the door support device. Therefore, it is particularly advantageous that the axial load can be equalized at the fully closed position.

During the automatic opening operation using the motor, the actuation force is generated as a positive component of the first axial load based on the driving force of the motor. The second axial load does not include an actuation force. When the door is at the fully opened position, the second spring load becomes larger than the first spring load, and the spring load difference becomes relatively large. The actuation force added to the first axial load is offset by the spring load difference. Therefore, during the automatic opening operation, the second axial load can be brought close to the first axial load.

During the automatic closing operation using the motor, the actuation force is included as a negative component in the first axial load. The second axial load does not include an actuation force. The spring load difference at the fully closed position is smaller than the spring load difference at the fully opened position. Therefore, during the automatic closing operation, particularly at the final stage thereof, the first axial load can be brought close to the second axial load.

According to the present invention, the axial load of the active type support member and the axial load of the passive type support member can be equalized.

### BRIEF DESCRIPTION OF DRAWINGS

FIG. 1 is a rear perspective view of a vehicle including a vehicle door support device according to an embodiment;

FIG. 2 is a schematic view of the door support device of FIG. 1;

FIG. 3 is a cross-sectional view of a first support member of FIG. 1;

FIG. 4 is a cross-sectional view of a second support member of FIG. 1;

FIG. 5 is a graph showing an axial load with respect to a door position during an automatic opening operation;

FIG. 6 is a graph showing an axial load with respect to a door position during an automatic closing operation;

FIG. 7 is a graph showing an axial load with respect to a door position during a manual opening operation; and

FIG. 8 is a graph showing an axial load with respect to a door position during a manual closing operation.

### DETAILED DESCRIPTION

Hereinafter, embodiments will be described with reference to the drawings. Note that the same or corresponding elements are denoted by the same reference numerals, and redundant detailed description will be omitted.

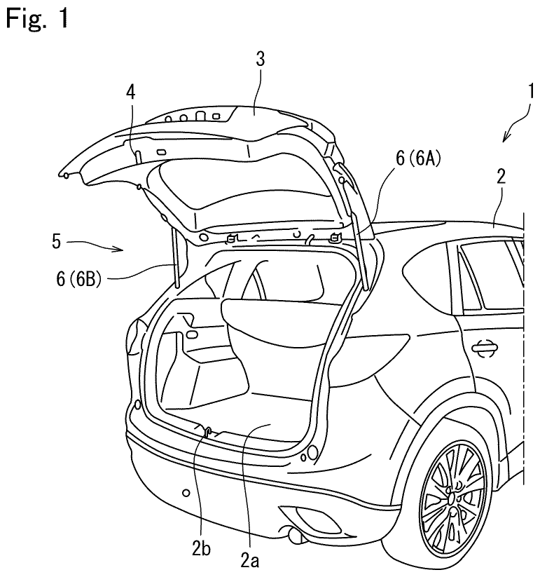

Referring to FIG. 1, a door support device 5 according to the present embodiment is applied to a vehicle 1 and supports a door 3 with respect to a vehicle body 2. The door 3 is supported by the door support device 5 so as to be displaceable with respect to the vehicle body 2 between a fully closed position where an opening 2a of the vehicle body 2 is fully closed and a fully opened position where the opening 2a is fully opened.

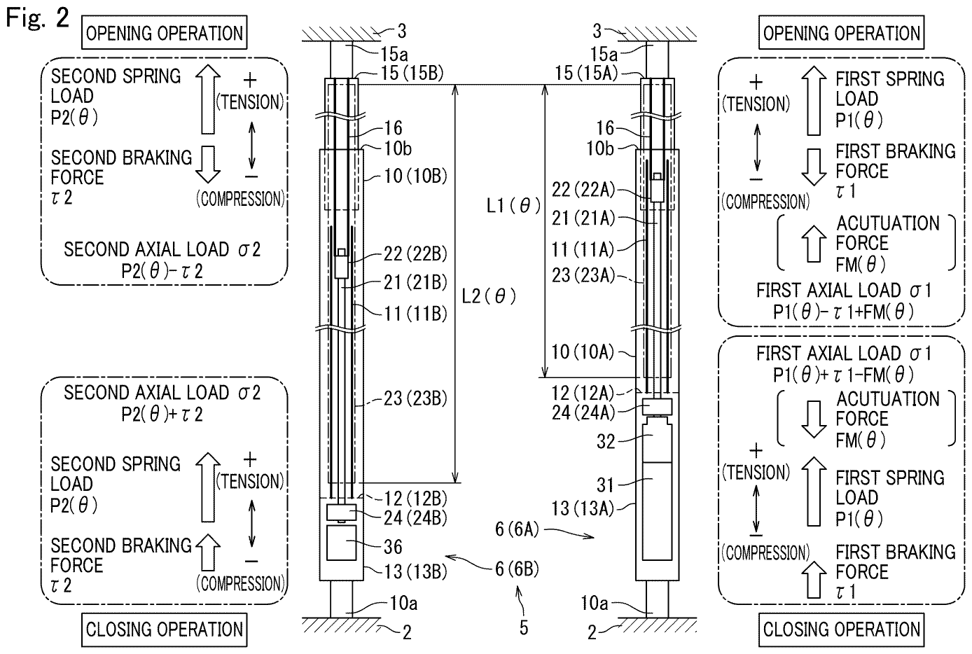

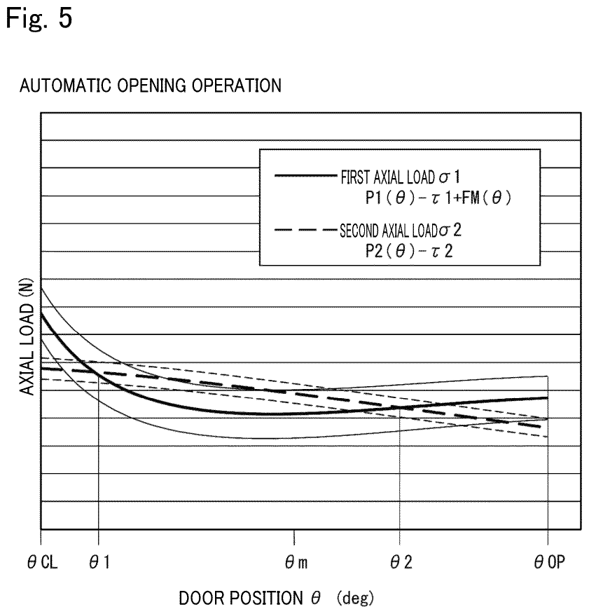

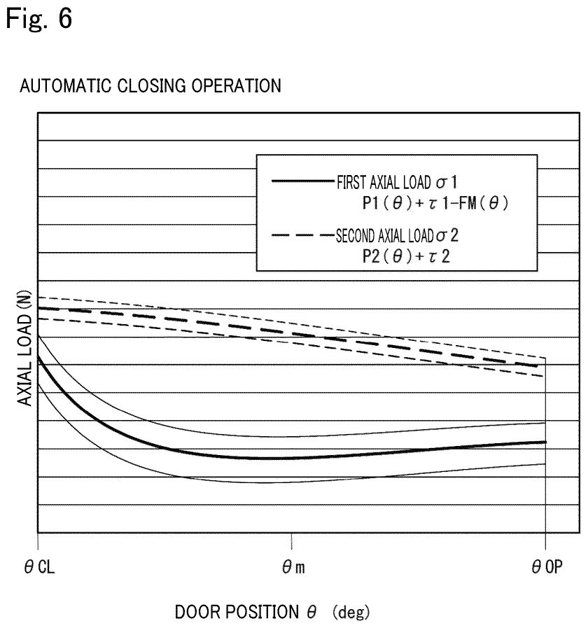

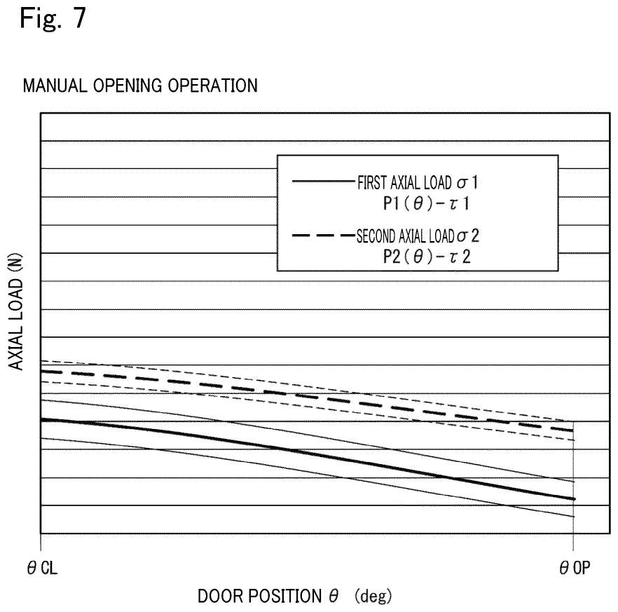

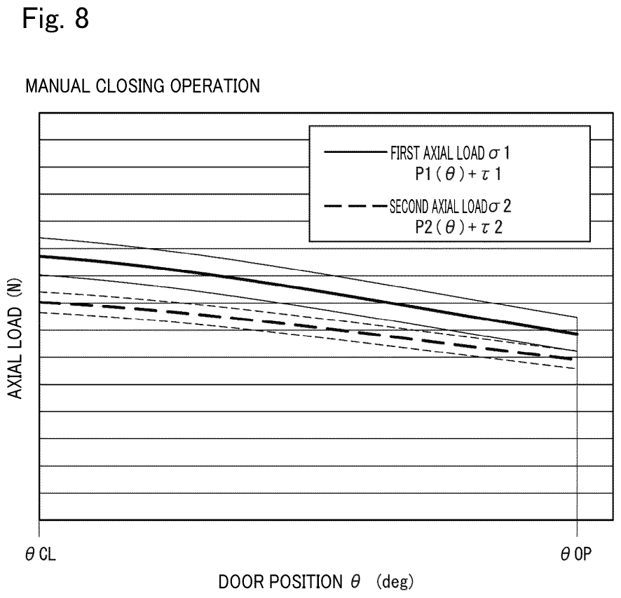

The operation of the door 3 includes an automatic operation (see FIGS. 5 and 6) generated by a driving force of a motor 31 (see FIG. 2) of the door support device 5 and a manual operation (see FIGS. 7 and 8) generated by an external force (typically, the operation force of the user of the vehicle 1) other than the driving force of the motor 31. The operation of the door 3 includes an opening operation (see FIGS. 5 and 7) in which the door position θ changes toward the fully opened position θOP and a closing operation (see FIGS. 6 and 8) in which the door position θ changes toward the fully closed position θCL.

The door 3 is provided with a latch mechanism 4 that detachably holds a striker 2b of the vehicle body 2. The striker 2b is provided on the peripheral edge of the opening 2a. When the door 3 reaches the fully closed position by the closing operation, the fully closed state is maintained by the action of a latch mechanism 4.

As an example, the opening 2a is provided at the rear portion of the vehicle body 2 to open a passenger compartment or a cargo compartment rearward. The door 3 is a back door that closes such an opening 2a in an openable manner. The back door is also referred to as a rear gate. The back door or the rear gate is rotatably attached to the vehicle body 2 by hinge connection, and a rotation axis thereof extends in the vehicle width direction at an upper edge of the opening 2a. The striker 2b is provided at the lower edge of the opening 2a. The door position θ is quantitatively expressed as an angle (deg) around the rotation axis.

The door support device 5 includes a pair of support members 6 that support the door 3 with respect to the vehicle body 2. One end of the support member 6 is pivotally connected to the vehicle body 2, and the other end of the support member 6 is pivotally connected to the door 3. The support member 6 is configured as an extendable rod body. In the opening operation, the support member 6 extends. In the closing operation, the support member 6 contracts.

The pair of support members 6 is disposed apart from each other in the vehicle width direction. In the illustrated example, a first support member 6A is disposed on the right side, and a second support member 6B is disposed on the left side, but this arrangement may be reversed left and right.

The first support member 6A is a so-called active type support member, and incorporates the motor 31 (see FIG. 2). The second support member 6B is a so-called passive type support member that follows the operation of the door 3, and does not include a motor.

Referring to FIGS. 2 to 4, each of the first support member 6A and the second support member 6B includes a fixed housing 10, a movable housing 15, a spindle 21, a spindle nut 22, a coil spring 23, and a brake 24. These members are coaxially arranged on a central axis C6 of the support member 6.

In the following description, when an element of the first support member 6A among elements common to the first support member 6A and the second support member 6B is referred to individually, an ordinal number “first” may be added to a name of the element, and a suffix “A” may be added to a reference sign of the element. Similarly, an ordinal number “second” and a suffix “B” may be used for the second support member 6B. When the first support member 6A and the second support member 6B are not distinguished from each other, ordinal numbers and suffixes may be omitted without particularly touching on it.

In the following description, with respect to the axial direction of the support member 6, a side approaching the connection partner of the fixed housing 10 is referred to as a “proximal end side”, and a side away from the connection partner of the fixed housing 10 is referred to as a “distal end side”. In the present embodiment, the fixed housing 10 is connected to the vehicle body 2, the movable housing 15 is connected to the door 3, and the vehicle body side is the proximal end side. However, the fixed housing 10 may be connected to the door 3, and the movable housing 15 may be connected to the vehicle body 2. In this case, the door side is the proximal end side.

The fixed housing 10 and the movable housing 15 are tubular. The fixed housing 10 has a first end portion 10a connected to the vehicle body 2 and a second end portion 10b opposite to the first end portion 10a. The movable housing 15 has a third end portion 15a connected to the door 3. The movable housing 15 is accommodated in the fixed housing 10 from the second end portion 10b on the side opposite to the third end portion 15a, and is movable in the axial direction with respect to the fixed housing 10.

The spindle 21 is accommodated in the fixed housing 10 and is rotatably supported about the central axis C6 with respect to the fixed housing 10. The spindle nut 22 is screwed to the spindle 21. The spindle nut 22 is coupled to the terminal end of the movable housing 15 via a push rod 16. The spindle nut 22 is axially displaceably and non-rotatably supported by a guide 11 fixed to the fixed housing 10.

The coil spring 23 biases the movable housing 15 in a direction in which the movable housing 15 advances from the fixed housing 10. The brake 24 mechanically applies rotational resistance to the spindle 21 when the movable housing 15 moves with respect to the fixed housing 10.

The fixed housing 10 has a partition 12 inside the proximal end portion, and forms a cylindrical accommodating portion 13 on the proximal end side (lower side of the paper surface of FIG. 2) with respect to the partition 12. The brake 24 is accommodated in the accommodating portion 13 and is adjacent to the partition 12. One end portion of the spindle 21 passes through the partition 12 and enters the accommodating portion 13. The brake 24 is attached to the outer periphery of one end portion of the spindle 21.

The first support member 6A includes a motor 31 that generates a driving force for driving the first spindle 21A, and a gear mechanism 32 that transmits the rotation of the motor 31 to the first spindle 21A. The motor 31, the gear mechanism 32, and the first brake 24A are accommodated in the first accommodating portion 13A in this order from the proximal end side in the axial direction. One end portion of the first spindle 21A is connected to the gear mechanism 32 and is connected to the motor 31 via the gear mechanism 32.

The second support member 6B does not include a motor and a gear mechanism. Alternatively, the second support member 6B may include a spacer 36. The spacer 36 can be accommodated in the second accommodating portion 13B and disposed on the proximal end side of the second brake 24B.

The coil spring 23 is accommodated inside the fixed housing 10 and the movable housing 15 in a state of being compressed from a natural length. The proximal end of the coil spring 23 is supported by the fixed housing 10 at a position adjacent to the terminal end side (upper side of the paper surface of FIG. 2) with respect to the partition 12. The terminal end of the coil spring 23 is supported by the terminal end portion of the movable housing 15. When the door 3 is operated, the advancing amount of the movable housing 15 with respect to the fixed housing 10 changes, the spring length changes, and the spring force exerted by the coil spring 23 changes. In the fully closed state, the spring length is minimized and the spring force is maximized, and in the fully opened state, the spring length is maximized and the spring force is minimized.

The entire length of the support member 6 (the distance in the axial direction from the connection point with the vehicle body 2 to the connection point with the door 3) and the posture of the support member 6 with respect to the vehicle body 2 change according to the displacement of the door 3. At any door position (that is, always), the first support member 6A and the second support member 6B are parallel to each other and have the same entire length. At any door position, the first support member 6A and the second support member 6B have the same distance from the connection point with the door 3 to the position where the terminal end of the coil spring 23 is supported.

On the other hand, the first accommodating portion 13A is longer than the second accommodating portion 13B due to the presence or absence of the motor 31, and the first partition 12A is located on the terminal end side with respect to the second partition 12B. In addition, the distance from the connection point with the vehicle body 2 to the position where the proximal end of the coil spring 23 is supported at any door position is longer in the first support member 6A than in the second support member 6B.

Therefore, at any door position, the first spring length L1(θ) of the first coil spring 23A is shorter than the second spring length L2(θ) of the second coil spring 23B. The difference between the first spring length L1(θ) and the second spring length L2(θ) can be adjusted by adjusting the axial length of the spacer 36 and thereby adjusting the position of the second partition 12B.

Regarding the manual opening operation, both the first support member 6A and the second support member 6B follow the displacement of the door 3. The movable housing 15 is pulled out from the fixed housing 10, and the push rod 16 moves with the spindle nut 22 to the terminal end side along the guide 11. Translation of the spindle nut 22 is converted into rotation of the spindle 21, and the spindle 21 rotates in the opening direction.

Also in the manual closing operation, both the first support member 6A and the second support member 6B follow the displacement of the door 3. The movable housing 15 is pushed into the fixed housing 10, and the push rod 16 moves to the proximal end side along the guide 11 together with the spindle nut 22. The translation of the spindle nut 22 is converted into the rotation of the spindle 21, and the spindle 21 rotates in the closing direction opposite to the opening direction.

Regarding the automatic opening operation, in the active type first support member 6A, the motor 31 rotates in the opening direction. The driving force of the motor 31 is transmitted to the first spindle 21A via the gear mechanism 32, and the first spindle 21A is rotationally driven in the opening direction. The rotation of the first spindle 21A is converted into translation of the first spindle nut 22A, and the first spindle nut 22A moves to the terminal end side along the first guide 11A. As a result, the first movable housing 15A is pushed out of the first fixed housing 10A, and the door position changes toward the fully opened position.

The passive type second support member 6B follows the displacement of the door 3. The second movable housing 15B is pulled out from the second fixed housing 10B, and the second spindle nut 22B moves to the terminal end side along the second guide 11B. As a result, the advancing amount of the second movable housing 15B follows the advancing amount of the first movable housing 15A, and the first support member 6A and the second support member 6B become parallel and equal in length at any door position. The translation of the second spindle nut 22B is converted into the rotation of the second spindle 21B, and the second spindle 21B rotates in the opening direction.

Regarding the automatic closing operation, in the active type first support member 6A, the motor 31 rotates in the closing direction. The driving force of the motor 31 is transmitted to the first spindle 21A via the gear mechanism 32, and the first spindle 21A is rotationally driven in the closing direction. The rotation of the first spindle 21A is converted into translation of the first spindle nut 22A, and the first spindle nut 22A moves to the proximal end side along the first guide 11A. As a result, the first movable housing 15A is pulled into the first fixed housing 10A, and the door position changes toward the fully closed position.

The passive type second support member 6B follows the displacement of the door 3. The second movable housing 15B is pushed into the second fixed housing 10B, and the second spindle nut 22B moves to the proximal end side along the second guide 11B. The translation of the second spindle nut 22B is converted into the rotation of the second spindle 21B, and the second spindle 21B rotates in the closing direction.

The brake 24 according to the present embodiment applies rotational resistance to the spindle 21 in both the first support member 6A and the second support member 6B in any of the above four operations.

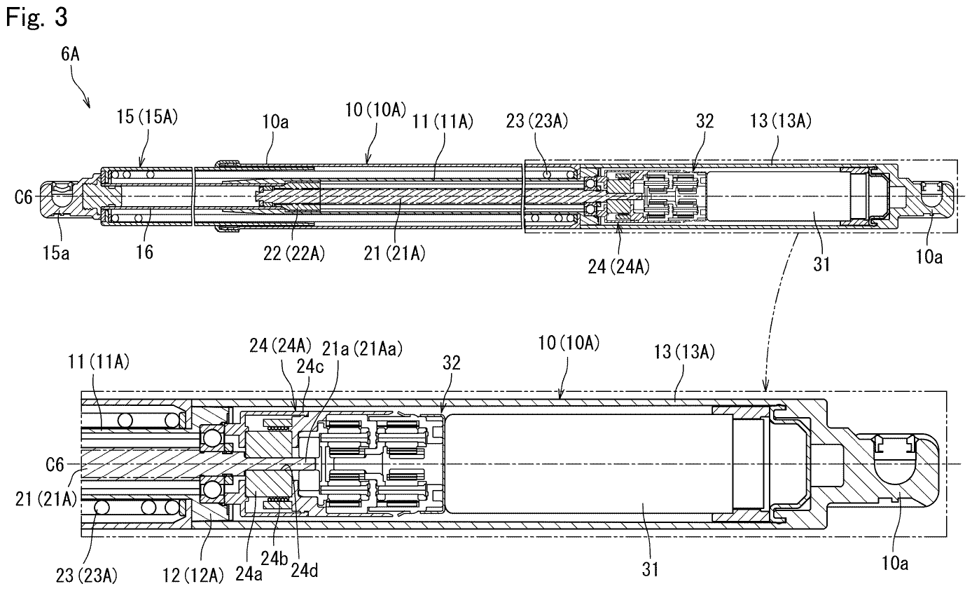

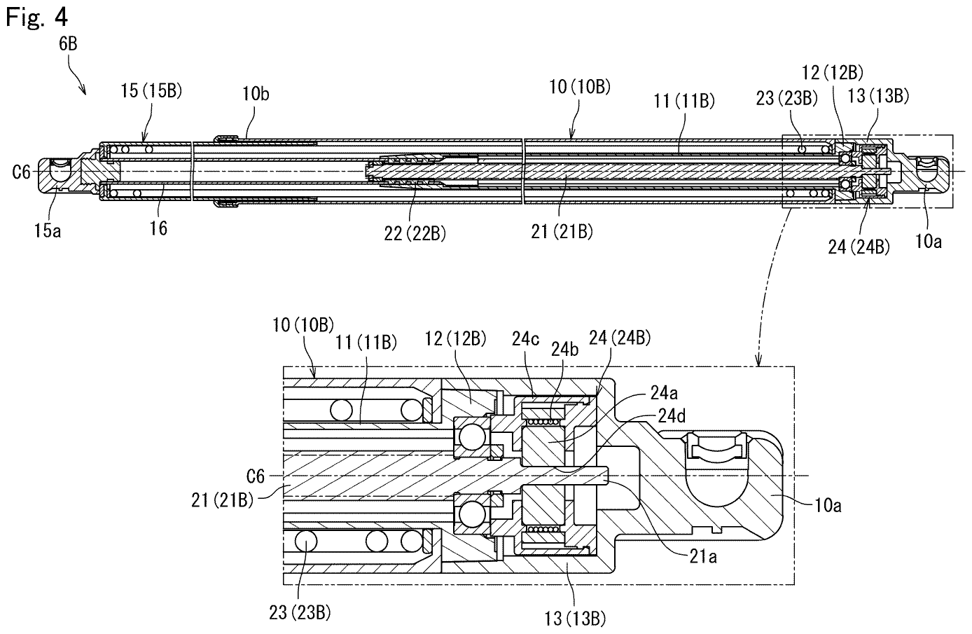

Referring to FIGS. 3 and 4, in the present embodiment, the brake 24 includes a rotary member 24a that rotates with respect to the fixed housing 10 integrally with the spindle 21, and a sliding contact member 24b that is fixed to the fixed housing 10 and slidably contacts an outer peripheral surface of the rotary member 24a. The brake 24 further includes a brake case 24c that accommodates the rotary member 24a and the sliding contact member 24b and is attached to the fixed housing 10.

The spindle 21 has a flat plate-shaped connection end portion 21a at one end, and the connection end portion 21a is inserted into a non-circular through hole 24d penetrating the rotary member 24a. As a result, the rotary member 24a is fitted to the spindle 21 in the rotation direction and rotates integrally with the spindle 21. A first connection end portion 21Aa of the first spindle 21A is connected to the gear mechanism 32 (see FIG. 3).

The outer peripheral surface of the rotary member 24a is a cylindrical surface. The sliding contact member 24b is, for example, a coil spring, is disposed so as to surround the outer periphery of the rotary member 24a, and elastically tightens the outer peripheral surface of the rotary member 24a. Both ends of the coil spring as the sliding contact member 24b are supported by the brake case 24c. When the spindle 21 rotates, the rotary member 24a slides with respect to the sliding contact member 24b. Friction between the rotary member 24a and the sliding contact member 24b is applied to the spindle 21 as rotational resistance.

Returning to FIG. 2, an axial load generated in the support member 6 during practical use of the door support device 5 will be described. The component in the tensile direction is positive, and the component in the compression direction is negative.

The first axial load σ1 of the first support member 6A includes, as main components thereof, a first spring load P1(θ) based on the spring force exerted by the first coil spring 23A and a first braking force τ1 based on the rotational resistance generated by the first brake 24A. The first axial load σ1 may further include an actuation force FM(θ) based on the thrust generated on the spindle nut 22 or the push rod 16 by the driving force of the motor 31.

The second axial load σ2 of the second support member 6B includes, as main components thereof, a second spring load P2(θ) based on the spring force exerted by the second coil spring 23B and a second braking force τ2 based on the rotational resistance generated by the second brake 24B.

The first spring load P1(θ) occurs both during operation and during stop of the door 3. The first spring load P1(θ) changes according to the door position θ. At any door position θ, the spring force acts in the direction in which the first movable housing 15A is advanced, that is, in the tensile direction of the first support member 6A. Therefore, at any door position θ, the first spring load P1(θ) becomes a positive component of the first axial load σ1 regardless of during opening operation, during closing operation, or during stop. The relationship between the second spring load P2(θ) and the second axial load σ2 is also similar to this.

The first braking force τ1 is generated during operation of the door 3 and is not generated during stop of the door 3. The first braking force τ1 becomes a negative component of the first axial load σ1 during opening operation, and becomes a positive component of the first axial load σ1 during closing operation. The relationship between the second braking force τ2 and the second axial load σ2 is similar to this.

The actuation force FM(θ) is included only in the first axial load σ1 during automatic operation. The actuation force FM(θ) is not included in the second axial load σ2 even during automatic operation, and is not generated during manual operation and during stop of the door 3. The actuation force FM(θ) is a component in a direction opposite to the braking force. The actuation force FM(θ) becomes a positive component of the first axial load σ1 during the automatic opening operation, and becomes a negative component of the first axial load σ1 during the automatic closing operation. The actuation force FM(θ) changes according to the operating direction of the door 3 and also changes according to the door position θ.

When there is a difference (hereinafter, axial load difference) between the first axial load σ1 and the second axial load σ2, a load acts on the door 3, and this load tends to deform the door 3. When the rigidity of the door 3 is sufficiently high, deformation of the door 3 is prevented against a load. However, in recent years, the size of the door 3 has been increased, and the resin usage rate of the components of the door 3 has been increased. In view of this recent trend, the influence of the axial load difference on the deformation of the door 3 may increase. When the door 3 is deformed, the operation of the door 3 may be affected, for example, the latch mechanism 4 may be displaced with respect to the striker 2b.

Therefore, the door support device 5 according to the present embodiment is configured as follows in order to equalize the first axial load σ1 and the second axial load σ2.

In the following description, the difference between the first spring load P1(θ) and the second spring load P2(θ) at the same door position θ is referred to as a “spring load difference ΔP(θ)”. The coil spring 23 is made of metal, and has an elastic coefficient that varies depending on the temperature. Unless otherwise specified, the spring load and the physical quantity (for example, a spring constant or the like) related to the spring load will be described as being in the same predetermined temperature environment (for example, 20° C.).

In the present embodiment, the spring load difference ΔP(θCL) in the fully closed state is smaller than the spring load difference ΔP(θOP) in the fully opened state. For example, the first coil spring 23A and the second coil spring 23B are configured such that the spring load difference ΔP(θCL) in the fully closed state becomes 0. That is, the first coil spring 23A and the second coil spring 23B are configured such that the first spring load P1(θCL) and the second spring load P2(θCL) in the fully closed state are equal.

When the door 3 is held at the fully closed position, the first axial load σ1 is equal to the first spring load P1(θCL), and the second axial load σ2 is equal to the second spring load P2(θCL). The axial load difference is small, for example, zero. Therefore, the load acting on the door 3 due to the axial load difference can be reduced or eliminated. Even when the rigidity of the door 3 is low, deformation of the door 3 can be prevented or suppressed. In practical use of the vehicle 1, the door 3 is held at the fully closed position for most of the period. In most of this period, the axial load difference can be reduced or eliminated, which is very beneficial for the door support device 5.

Here, the advancing amount of the movable housing 15 from the fully closed state to the fully opened state is the same between the first support member 6A and the second support member 6B. Therefore, the first support member 6A and the second support member 6B have the same extension amount (amount of change in spring length) of the coil spring 23 from the fully closed state to the fully opened state.

On the other hand, the first spring constant of the first coil spring 23A is set higher than the second spring constant of the second coil spring 23B. The spring constant can be appropriately adjusted by adjusting or selecting, for example, the pitch of the spring, the wire diameter of the spring, the outer diameter of the spring, the material of the spring, and the like.

Since the extension amount is the same and the spring constant is different, the attenuation amount of the first spring load P1(θ) from the fully closed state to the fully opened state is larger than the attenuation amount of the second spring load P2(θ). In the fully opened state, the second spring load P2(θOP) is larger than the first spring load P1(θOP). As described above, the spring load difference ΔP(θOP) in the fully opened state is larger than the spring load difference ΔP(CL) in the fully closed state.

The amount of contraction from the natural length in the fully closed state is smaller in the first coil spring 23A than in the second coil spring 23B. This makes it possible to equalize the spring force in the fully closed state with different spring constants. Since the first coil spring 23A is shorter in the amount of contraction from the natural length and the spring length after contraction, the first coil spring 23A is shorter in the natural length.

Furthermore, the first brake 24A and the second brake 24B are configured such that the first braking force τ1 is larger than the second braking force τ2. The braking force can be appropriately adjusted, for example, by changing the number of turns or the wire diameter of the coil spring as the sliding contact member 24b. As an example of a case using this adjustment method, the number of turns of the first brake 24A is larger than the number of turns of the second brake 24B.

FIGS. 5 to 8 show the first axial load σ1 and the second axial load σ2 with respect to the door position θ during the automatic opening operation, the automatic closing operation, the manual opening operation, and the manual closing operation, respectively. Note that it is assumed that the vehicle 1 is grounded to the horizontal ground. FIGS. 5 and 7 illustrate the opening operation in which the door position θ changes from left to right with time. FIGS. 6 and 8 illustrate the closing operation in which the door position θ changes from right to left with time. A solid line indicates the first axial load σ1, and a broken line indicates the second axial load σ2. The rotational resistance of the brake 24 varies. A thick line indicates the axial load when the rotational resistance is the median value or the average value, and a thin line indicates the axial load when the rotational resistance is the maximum value or the minimum value in the variation range.

Referring to FIGS. 5 and 7, in the passive type second support member 6B, the second axial load σ2 is substantially the same between the automatic opening operation and the manual opening operation. As the door position θ approaches the fully opened position θOP, the second axial load σ2 gradually decreases downward to the right due to the decrease in the second spring load P2(θ).

Referring to FIG. 7, in the manual opening operation, similarly to the second support member 6B, also in the active type first support member 6A, as the door position θ approaches the fully opened position θOP, the first axial load σ1 gradually decreases due to the decrease in the first spring load P1(θ). Since the first spring constant is larger than the second spring constant, the degree of decrease of the first axial load σ1 is larger than that of the second axial load σ2, and the spring load difference ΔP(θ) gradually increases. Since the first braking force τ1 is larger than the second braking force τ2 and the first braking force τ1 and the second braking force τ2 are negative components, the first axial load σ1 remains at a value lower than the second axial load σ2.

Referring to FIG. 5, in the active type first support member 6A during the automatic opening operation, the actuation force FM(θ) is added to the first axial load σ1 as a positive component. As can be seen by referring to FIG. 5 together with FIG. 7, the actuation force FM(θ) transitions along a downward convex curve, and this tendency of the actuation force FM(θ) is reflected in the tendency of the first axial load σ1.

Here, the door position just at the center between the fully closed position θCL and the fully opened position θOP is defined as an “intermediate position θm”. As can be seen from the tendency of the first axial load σ1, the actuation force FM(θ) shows a high value at the start of the automatic opening operation and rapidly decreases at the initial stage of the automatic opening operation. The actuation force FM(θ) turns from decrease to increase near the intermediate position θm. In the second half stage of the automatic opening operation, the actuation force FM(θ) gradually increases until the door position θ reaches the fully opened position θOP.

The actuation force FM(θ) as the positive component offsets the difference between the first braking force τ1 and the second braking force τ2 as the negative component. Conversely, since the first braking force τ1 is set to be larger than the second braking force τ2, the actuation force FM(θ) input during the automatic opening operation is offset by the relatively large first braking force τ1.

The gradual increase in the actuation force FM(θ) in the second half stage of the automatic opening operation offsets the gradual increase in the spring load difference ΔP(θ). Conversely, the spring load difference ΔP(θOP) in the fully opened state is made larger than the spring load difference ΔP(θCL) in the fully closed state, and the second spring load P2(θOP) in the fully opened state is made larger than the first spring load P1(θOP). As a result, the gradual increase in the actuation force FM(θ) during the automatic opening operation is offset by the gradual increase in the spring load difference ΔP(θ) and the relatively small first spring load P1(θOP).

In this manner, the first axial load σ1 is brought close to the second axial load σ2 during the automatic opening operation. In particular, the first axial load σ1 is once equal to the second axial load σ2 at the first position θ1 in the rapid decrease section in the initial stage. The first axial load σ1 becomes equal to the second axial load σ2 again at the second position θ2 in the gradual increase section in the second half stage. The first position θ1 is closer to the fully closed position θCL than the intermediate position θm, and the second position θ2 is closer to the fully opened position θOP than the intermediate position θm. The axial load difference is kept small throughout the automatic opening operation from the fully closed position θCL to the fully opened position θOP.

Referring to FIGS. 6 and 8, in the passive type second support member 6B, the second axial load σ2 is substantially the same between the automatic closing operation and the manual closing operation. As the door position θ approaches the fully closed position θCL, the second axial load σ2 gradually increases upward to the left due to an increase in the second spring load P2(θ).

Referring to FIG. 8, in the manual closing operation, similarly to the second support member 6B, also in the active type first support member 6A, as the door position θ approaches the fully closed position θCL, the first axial load σ1 gradually increases due to the increase in the first spring load P1(θ). Since the first spring constant is larger than the second spring constant, the degree of increase in the first axial load σ1 is larger than that in the second axial load σ2, and the spring load difference ΔP(θ) gradually decreases. Since the first braking force τ1 is larger than the second braking force τ2 and the first braking force τ1 and the second braking force τ2 are positive components, the first axial load σ1 transitions at a higher value than the second axial load σ2.

Referring to FIG. 6, in the active type first support member 6A during the automatic closing operation, the actuation force FM(θ) is added to the first axial load σ1 as a negative component. As can be seen by referring to FIG. 6 together with FIG. 8, the absolute value of the actuation force FM(θ) transitions along an upwardly convex curve. This tendency of the actuation force FM(θ) acts as a negative component and is reflected in the tendency of the first axial load σ1.

As can be seen from the vertical reversal of the tendency of the first axial load σ1, the absolute value of the actuation force FM(θ) shows a high value at the start of the automatic closing operation and gradually increases in the first half stage of the automatic opening operation. The absolute value of the actuation force FM(θ) changes from increase to decrease near the intermediate position θm. At the final stage of the automatic closing operation, the absolute value of the actuation force FM(θ) rapidly decreases until the door position θ reaches the fully opened position θOP. The tendency of the absolute value is reflected on the tendency of the first axial load σ1 in such a manner that the increase and decrease are reversed. The first axial load σ1 gradually decreases from a value lower than the second axial load σ2 and rapidly increases at the final stage.

The actuation force FM(θ) as the negative component offsets the difference between the first braking force τ1 and the second braking force τ2 as the positive component. Conversely, since the first braking force τ1 is set to be larger than the second braking force τ2, the negative action of the actuation force FM(θ) in the automatic closing operation is offset by the relatively large first braking force τ1.

If the first braking force τ1 and the second braking force τ2 are equal to each other, even if the first axial load σ1 rapidly increases at the final stage of the automatic closing operation, there is a possibility that the first axial load σ1 does not sufficiently approach the second axial load σ2. In this case, the door 3 may be deformed due to the axial load difference, which may interfere with the engagement between the latch mechanism 4 and the striker 2b. By setting the first braking force τ1 to be larger than the second braking force τ2, the first axial load σ1 is brought close to the second axial load σ2 particularly at the final stage of the automatic closing operation. This contributes to stable operation of the door 3.

As described above, according to the present embodiment, the first coil spring 23A and the second coil spring 23B are configured such that the spring load difference ΔP(θCL) when the door position θ is at the fully closed position θCL is smaller than the spring load difference ΔP(θOP) when the door position θ is at the fully opened position θOP. As a result, while the door position θ is held at the fully closed position θCL, that is, during most of the practical period of the vehicle 1, the axial load difference becomes relatively small, and the load acting on the door 3 due to the axial load difference can be reduced or eliminated.

In the above description, for ease of understanding, zero is exemplified as the spring load difference ΔP(θCL) in the fully closed state. This is merely an example. The spring load difference ΔP(θCL) in the fully closed state may be set within a range that does not affect deformation of the door 3. For example, a value obtained by dividing the spring load difference ΔP(θCL) by the first spring load P1(θCL) or the second spring load P2(θCL) may fall within a range of 10%, preferably 5%.

Further, the first coil spring 23A and the second coil spring 23B are configured such that the second spring load P2(θOP) is larger than the first spring load P1(θOP) when the door position θ is at the fully opened position θOP. As a result, during the automatic opening operation, the actuation force FM(θ) input as a positive component to the first axial load σ1 is offset by the relatively large second spring load P2(θOP). Therefore, during the automatic opening operation, the first axial load σ1 and the second axial load σ2 are equalized.

Furthermore, the first brake 24A and the second brake 24B are configured such that the first braking force τ1 is larger than the second braking force τ2.

As a result, during the automatic opening operation, the actuation force FM(θ) input as a positive component to the first axial load σ1 is input as a negative component to the first axial load σ1, and is offset by the relatively large first braking force τ1. Since the second spring load P2(θOP) in the fully opened state is also relatively large, the first axial load σ1 and the second axial load σ2 are equalized during the automatic opening operation.

During the automatic closing operation, the actuation force FM(θ) input as a negative component to the first axial load σ1 is offset by the relatively large first braking force τ1. Since the spring load difference ΔP(θCL) in the fully closed state is relatively small, the first axial load σ1 and the second axial load σ2 are equalized during the automatic closing operation, particularly at the final stage thereof.

In the present embodiment, when the vehicle door support device includes the active type first support member 6A and the passive type second support member 6B, both the first support member 6A and the second support member 6B are provided with brakes. Therefore, even when the unit is detached in the compressed state, any of the support members 6 can prevent rapid extension by the action of the brake. In the present embodiment, the second braking force τ2 of the second support member 6B is set to be smaller than the first braking force τ1 of the first support member 6A. However, since the brakes are applied to both the support members, it is possible to effectively prevent sudden extension.

The configuration of the above embodiment is merely an example, and can be appropriately changed within the scope of the present invention.

What is claimed is:

1. A vehicle door support device comprising a first support member and a second support member that support a door with respect to a vehicle body, wherein
each of the first support member and the second support member includes:
a tubular fixed housing having a first end portion connected to one of the vehicle body and the door and a second end portion opposite to the first end portion;
a tubular movable housing that has a third end portion connected to the other of the vehicle body and the door, is accommodated in the fixed housing from the second end portion on a side opposite to the third end portion, and is movable in an axial direction with respect to the fixed housing;
a spindle rotatably supported within the fixed housing;
a spindle nut screwed to the spindle and coupled to the movable housing; and
a coil spring that biases the movable housing in a direction in which the movable housing advances from the fixed housing,
the first support member is an active type support member including a motor that drives the spindle of the first support member, and the second support member is a passive type support member that follows an operation of the door, and
when the coil spring of the first support member is a first coil spring, a component of a first axial load acting on the first support member from the first coil spring is a first spring load, the coil spring of the second support member is a second coil spring, a component of a second axial load acting on the second support member from the second coil spring is a second spring load, and a difference between the first spring load and the second spring load at the same door position is a spring load difference,
the first coil spring and the second coil spring are configured such that
the spring load difference when the door position is in the fully closed position is smaller than the spring load difference when the door position is in the fully opened position, and
the second spring load is larger than the first spring load when the door position is the fully opened position.

2. The vehicle door support device according to claim 1, wherein
each of the first support member and the second support member further includes a brake that mechanically applies rotational resistance to the spindle when the movable housing moves with respect to the fixed housing, and
when the brake of the first support member is a first brake, a component of the first axial load acting on the first support member from the first brake is a first braking force, the brake of the second support member is a second brake, and a component of the second axial load acting on the second support member from the second brake is a second braking force,
the first brake and the second brake are configured such that the first braking force is larger than the second braking force.

3. The vehicle door support device according to claim 2, wherein
the brake includes:
a rotary member that rotates integrally with the spindle; and
a sliding contact member fixed to the fixed housing and slidably contacting the rotary member.

4. The vehicle door support device according to claim 1, wherein the first axial load and the second axial load are equivalent to each other when the door position is at a first position and a second position during an automatic opening operation in which the motor displaces the door toward the fully opened position.

5. The vehicle door support device according to claim 2, wherein the first axial load and the second axial load are equivalent to each other when the door position is at a first position and a second position during an automatic opening operation in which the motor displaces the door toward the fully opened position.

6. The vehicle door support device according to claim 3, wherein the first axial load and the second axial load are equivalent to each other when the door position is at a first position and a second position during an automatic opening operation in which the motor displaces the door toward the fully opened position.

7. The vehicle door support device according to claim 1, wherein a spring constant of the first coil spring is larger than a spring constant of the second coil spring.

8. The vehicle door support device according to claim 2, wherein a spring constant of the first coil spring is larger than a spring constant of the second coil spring.

9. The vehicle door support device according to claim 3, wherein a spring constant of the first coil spring is larger than a spring constant of the second coil spring.

10. The vehicle door support device according to claim 4, wherein a spring constant of the first coil spring is larger than a spring constant of the second coil spring.
